(19) United States
(12) Patent Application Publication
(10) Pub. No.: US 2005/0004793 A1
(43) Pub. Date: Jan. 6, 2005

(54) Signal adaptation for higher band coding in a codec utilizing band split coding

(76) Inventors: Pasi Ojala, Kauniainen (FI); Janne Vainio, Lempaala (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/838,641

(22) Filed: May 4, 2004

Related U.S. Application Data
(60) Provisional application No. 60/484,961, filed on Jul. 3, 2003.

(51) Int. Cl. G10L 19/04

(52) U.S. Cl. 704/219

(57) ABSTRACT

The present invention describes a novel methodology for adjusting a bandwidth extension algorithm by adapting one or more of enhancing perception parameters (e.g., a signal level, a signal energy and/or a gain) of a high-band encoded signal based on the characteristics of the input signal and an encoding performance in a low band with a codec utilizing audio-band-split coding by separate encoders and decoders for each audio band. The adaptation is based on the low-band coding algorithm. It can be at least two types of such an algorithm: e.g., an algebraic code excitation linear prediction (ACELP) algorithm for a speech-like input signal and a transform algorithm of a non-speech-like input signal, such that when the ACELP coding is selected, the corresponding enhancing perception parameter is gradually tuned down and when the encoding algorithm is changed to the transform coding, the corresponding enhancing perception parameter is gradually tuned up.

### FIELD OF THE INVENTION

The invention generally relates to audio coding, and more specifically to adjusting a bandwidth extension algorithm by a signal adaptation for a higher band coding in a codec utilizing band-split coding with separate encoders and decoders for each audio band.

### BACKGROUND OF THE INVENTION

Audio codec bandwidth extension algorithms typically relate to encoding functions as well as encoding parameters from a core encoder. That is, the encoded audio bandwidth, e.g., is split into two out of which the lower (or low) band is considered to be a core encoder. The higher (or high) band is then coded using a knowledge about the encoding parameters and signals from the core band. Since in most cases the low and high audio bands correlate with each other, the low band parameters can also be used in the high band. When the parameters are available in the low band decoder the method reduces a bit rate of the high band encoding significantly.

An example of a split band coding algorithm is the extended AMR-WB (AMR-WB+) codec (adaptive multi-rate wide band speech/audio codec). The core encoder contains full source signal encoding algorithms while a linear prediction coding (LPC) excitation signal of the high-band encoder is copied from the core encoder or is a locally generated random signal.

In the extended AMR-WB (AMR-WB+) the low band coding can utilize either ACELP (algebraic code excitation linear prediction) type or transform based algorithms such as TCX (transform coded excitation). The selection between the algorithms is done based on the input signal characteristics. Typically, the ACELP algorithm is used for speech signal and for transients while music and tone like signals are encoded using the transform coding to better handle the frequency resolution.

In the extended AMR-WB (AMR-WB+) the high-band encoding utilizes a linear prediction coding (LPC) to model the spectral envelope of the high-band signal. To minimize a bit rate, the excitation signal is generated by up-sampling the low-band excitation to the high band. That is, the low band excitation is reused at the high band by transposing it to the high band. Another method is to generate a random excitation signal (as pointed out above) for the high band. The synthesized high band signal is reconstructed by filtering the excitation signal through the LPC model.

After the high-band synthesis the signal energy is adjusted to match to the energy of the original high-band signal. The intention is to keep the signal energy at the same level. However, since the excitation signal is either copied from the low band or randomly generated, the synthesized high band signal does not fully reconstruct the original signal. Especially for speech, when the ACELP algorithm is used for the low band, the high band coding can cause a very high perceived signal level in the high band which can be heard as an annoying high frequency noise. This is caused by the fact that even when the energy of the reconstructed high band is the same as the original energy, the frequency content of the high band differs enough to cause a difference in the perceived loudness of the signal. Therefore, it is desirable to adjust (adapt) the synthesized signal in order to compensate the perceived loudness.

### SUMMARY OF THE INVENTION

The object of the present invention is to provide a novel method for adjusting a bandwidth extension algorithm by a signal adaptation for a higher band coding based on the characteristics of an encoding performance in a low band with a codec utilizing audio-band-split coding with separate encoders and decoders for each audio band.

According to a first aspect of the invention, a method of adjusting a bandwidth extension algorithm for band-split encoding and decoding using analysis and synthesis filterbanks and separate encoders and decoders for each band, comprising the steps of: receiving by a high-band encoder an indication signal generated by a low-band encoder in response to a low-band signal from said analysis filterbank; and adjusting by the high-band encoder an enhancing perception parameter of a high-band encoded signal generated by the high-band encoder in response to a high-band signal from said analysis filterbank and based on said indication signal thus adjusting said bandwidth extension algorithm, wherein the high-band signal and the low-band signal represent two signals out of M frequency-band signals generated by the analysis filterbank by splitting an input signal into M frequency bands, M is an integer of at least a value of two and a band frequency range of said high-band signal is higher than the band frequency range of said low-band signal, and wherein the high-band and low-band encoders with the analysis filterbank form a transmitter of the input signal and the high-band and low-band decoders with the synthesis filterbank form a receiver of a re-transmitted input signal which is spectrally encoded in said M bands with said adjustment applied to the high-band encoded signal.

According further to the first aspect of the invention, prior to said adjustment, said enhancing perception parameter may be generated in response to an excitation signal from the low-band encoder or from a random signal generator.

Further according to the first aspect of the invention, the enhancing perception parameter may be a signal level, a gain, or a signal energy, or their combination thereof.

Still further according to the first aspect of the invention, M may be equal to 2.

According further to the first aspect of the invention, the indication signal may be an indicator of an algebraic code excitation linear prediction (ACELP) type of coding used by the low-band encoder for generating the low-band signal for the input signal which is speech-like. Further, based on said indication signal, said enhancing perception parameter may be gradually adjusted downwards towards a minimum threshold value until said threshold value is reached.

According still further to the first aspect of the invention, the indication signal may be an indicator of a transform type of coding used by the low-band encoder for generating the low-band signal for the input signal which is non-speech-like. Further, based on said indication signal, the enhancing perception parameter may be gradually adjusted upwards towards a maximum threshold value until said threshold value is reached.

According further still to the first aspect of the invention, based on said indication signal, the enhancing perception parameter is gradually adjusted towards a threshold value until said threshold value is reached. Further, the threshold value may be a predetermined value, determined based on the input signal or provided by a sender of the input signal. Still further, the threshold value may be a minimum threshold value and the enhancing perception parameter may be gradually adjusted downwards towards said minimum threshold value until said minimum threshold value is reached or the threshold value may be a maximum threshold value and the enhancing perception parameter is gradually adjusted upwards towards a maximum threshold value until said maximum threshold value is reached. Yet still further, the maximum threshold or the minimum threshold may be a predetermined value.

According yet further still to the first aspect of the invention, the enhancing perception parameter of the high-band encoded signal may be quantized before said adjusting and, in response to the high-band encoded signal received by a high-band decoder, said enhancing perception parameter of a high-band decoded signal generated by said high-band decoder may be adjusted by said high-band decoder based on a further indication signal generated by a low-band decoder in response to a low-band encoded signal from the low band encoder and containing identical information as said indication signal thus further adjusting said bandwidth extension algorithm to keep synchronization with said adjustment performed by the high-band encoder.

According to a second aspect of the invention, a computer program product may comprise: a computer readable storage structure embodying computer program code thereon for execution by a computer processor with said computer program code characterized in that it includes instructions for performing the steps of the first aspect of the invention indicated as being performed by any component of the transmitter or of the receiver or a combination of such components.

According to a third aspect of the invention, a system for adjusting a bandwidth extension algorithm for band-split encoding and decoding, comprising: an analysis filterbank, responsive to an input signal, for providing M frequency-band signals generated by splitting the input signal into M frequency bands, wherein M is an integer of at least a value of two; a high-band encoder, responsive to a high-band signal and to an indication signal, for providing a high-band encoded signal and for adjusting an enhancing perception parameter of the high-band encoded signal thus adjusting said bandwidth extension algorithm; and a low-band encoder, responsive to a low-band signal, for providing said indication signal, wherein the high-band signal and the low-band signal represent two signals out of said M frequency-band signals generated by the analysis filterbank and a band frequency range of said high-band signal is higher than the band frequency range of said low-band signal.

According further to the third aspect of the invention, prior to said adjustment the enhancing perception parameter may be generated in response to an excitation signal from the low-band encoder or from a random signal generator.

Further according to the third aspect of the invention, the enhancing perception parameter may be a signal level, a gain, or a signal energy, or their combination thereof.

Still further according to the third aspect of the invention, M may be equal to 2.

According further to the third aspect of the invention, the indication signal may be an indicator of an algebraic code excitation linear prediction (ACELP) type of coding used by the low-band encoder for generating the low-band signal for the input signal which is speech-like. Further, based on said indication signal, said enhancing perception parameter may be gradually adjusted downwards towards a minimum threshold value until said threshold value is reached.

According still further to the third aspect of the invention, the indication signal may be an indicator of a transform type of coding used by the low-band encoder for generating the low-band signal for the input signal which is non-speech-like. Further, based on said indication signal, said enhancing perception parameter may be gradually adjusted upwards towards a maximum threshold value until said threshold value is reached.

According yet further still to the third aspect of the invention, based on said indication signal, said enhancing perception parameter is gradually adjusted towards a threshold value until said threshold value is reached. Further, said threshold value may be a predetermined value, determined based on the input signal or provided by a sender of the input signal. Still further, said threshold value may be a minimum threshold value and said enhancing perception parameter is gradually adjusted downwards towards said minimum threshold value until said minimum threshold value is reached or said threshold value may be a maximum threshold value and said enhancing perception parameter is gradually adjusted upwards towards a maximum threshold value until said maximum threshold value is reached. Yet still further, the maximum threshold or the minimum threshold may be a predetermined value.

According further still to the third aspect of the invention, the system may be contained in a portable electronic device, an electronic communication device, a mobile electronic device, a mobile phone or a communication network element.

Yet still further according to the third aspect of the invention, the system may further comprise: a high-band decoder, responsive to the high-band encoded signal for providing a high-band decoded signal; a low-band decoder, responsive to a low-band encoded signal generated by the low-band encoder, for providing a low-band decoded signal; and a synthesis filterbank, responsive to the high-band decoded signal and to the low-band decoded signal, for providing a synthesized output signal,
wherein the high-band and low-band encoders with the analysis filterbank form a transmitter of the input signal and the high-band and low-band decoders with the synthesis filterbank form a receiver of a re-transmitted input signal which is spectrally encoded in said M bands with said adjustment applied to the high-band encoded signal.

According to a fourth aspect of the invention, an electronic device, capable of adjusting a bandwidth extension algorithm for band-split encoding, comprising: an analysis filterbank, responsive to an input signal, for providing M frequency-band signals generated by splitting the input signal into M frequency bands, wherein M is an integer of at least a value of two; a high-band encoder, responsive to a high-band signal and to an indication signal, for providing a high-band encoded signal and for adjusting an enhancing perception parameter of the high-band encoded signal thus adjusting said bandwidth extension algorithm; and a low-band encoder, responsive to a low-band signal, for providing said indication signal and for providing a low-band encoded signal, wherein the high-band signal and the low-band signal represent two signals out of said M frequency-band signals generated by the analysis filterbank and a band frequency range of said high-band signal is higher than the band frequency range of said low-band signal.

According further to the fourth aspect of the invention, the electronic device may be a portable electronic device, an electronic communication device, a mobile electronic device, a mobile phone or a communication network element.

Further according to the fourth aspect of the invention, prior to said adjustment, said enhancing perception parameter may be generated in response to an excitation signal from the low-band encoder or from a random signal generator.

Still further according to the fourth aspect of the invention, said enhancing perception parameter may be a signal level, a gain, or a signal energy, or their combination thereof.

According further to the fourth aspect of the invention, M may be equal to 2.

According still further to the fourth aspect of the invention, said indication signal may be an indicator of an algebraic code excitation linear prediction (ACELP) type of coding used by the low-band encoder for generating the low-band signal for the input signal which is speech-like. Further, based on said indication signal, said enhancing perception parameter may be gradually adjusted downwards towards a minimum threshold value until said threshold value is reached.

According further still to the fourth aspect of the invention, indicator of an algebraic code excitation linear prediction (ACELP) type of coding used by the low-band encoder for generating the low-band signal for the input signal which is speech-like. Further, based on said indication signal, said enhancing perception parameter may be gradually adjusted downwards towards a minimum threshold value until said threshold value is reached. Still further, said indication signal is an indicator of a transform type of coding used by the low-band encoder for generating the low-band signal for the input signal which is non-speech-like. Yet still further, based on said indication signal, said enhancing perception parameter may be gradually adjusted upwards towards a maximum threshold value until said threshold value is reached.

Yet still further according to the fourth aspect of the invention, based on said indication signal, said enhancing perception parameter may be gradually adjusted towards a threshold value until said threshold value is reached. Further, said threshold value may be a predetermined value, determined based on the input signal or provided by a sender of the input signal. Still further, said threshold value may be a minimum threshold value and said enhancing perception parameter is gradually adjusted downwards towards said minimum threshold value until said minimum threshold value is reached or said threshold value may be a maximum threshold value and said enhancing perception parameter is gradually adjusted upwards towards a maximum threshold value until said maximum threshold value is reached. Yet still further, the maximum threshold or the minimum threshold may be a predetermined value.

### BRIEF DESCRIPTION OF THE DRAWINGS

For a better understanding of the nature and objects of the present invention, reference is made to the following detailed description taken in conjunction with the following drawings, in which:

FIG. 1a shows an example of a general block diagram demonstrating a band-split encoding/decoding concept for adjusting a bandwidth extension algorithm using a high-band encoded signal adaptation with two band filterbanks and separate encoders and decoders for each audio band, according to the present invention.

FIG. 1b shows an example of a frequency response of a two-band analysis filterbank for a 12 kHz audio band, which can be used in the block diagram of FIG. 1, according to the present invention.

FIG. 2 shows an example demonstrating a functionality of a high-band encoder, according to the prior art.

FIG. 3 shows an example demonstrating a functionality of a high-band encoder with a high-band encoded signal adaptation, according to the present invention.

### BEST MODE FOR CARRYING OUT THE INVENTION

The present invention provides a novel methodology for adjusting a bandwidth extension algorithm by adapting one or more of enhancing perception parameters (e.g., a signal level, a signal energy and/or a gain) of a high-band encoded signal for a high-band coding based on the characteristics of the input signal and an encoding performance in a low band with a codec utilizing audio-band-split coding with separate encoders and decoders for each audio band.

In a typical system to which the present invention can be referred, an extended AMR-WB (AMR-WB+) codec (adaptive multi rate wide band speech/audio codec) is applied to a band-split structure in which the audio bandwidth is divided, e.g., in two parts before the encoding process. Both bands are encoded independently. However, to minimize a bit rate, the higher (or high) band is encoded using bandwidth extension techniques. That is, a part of the high-band encoding is dependent on the low-band encoding. For example, the high-band excitation signal for an LPC-synthesis (linear prediction coding synthesis) is copied from the low-band encoder (core encoder) or generated locally. For example, in the AMR-WB+ codec the low-band range is from 0 to 6.4 kHz, while the high band is from 6.4 to 12 kHz for 24 kHz sampling frequency.

According to the present invention, the new method adaptively controls the high-band encoded signal (e.g., adapting the signal level, the signal energy or the gain) depending on the low-band coding algorithm. There can be at least two types of such an algorithm: e.g., an ACELP (algebraic code excitation linear prediction) pulse-like algorithm and a transform coded TCX (transform codec excitation) algorithm. For the ACELP coding algorithm, according to the present invention, the method suppresses the enhancing perception parameter (or parameters) of the high-band encoded signal in order to avoid audible high frequency noise components in a speech signal. More specifically, in order not to cause audible transients in the signal and not to suppress individual frames containing transients, the high-band encoded signal is adaptively tuned based on the low-band coding algorithm. When the ACELP coding is selected, the corresponding enhancing perception parameter of the high-band encoded signal is gradually tuned down (adapted) to a predetermined minimum value. On the other hand, when the encoding algorithm is changed to the transform coding, the corresponding enhancing perception parameter of the high-band encoded signal is gradually tuned back up to a normal level (a predetermined maximum value) optimal for non-speech signals like music.

According to the present invention, the encoding process features can be summarized as follows:
Audio encoding is done in a sub-band domain by splitting the audio band into the low and high bands;
The core (low-band) encoder is utilized to encode the low audio band;
High-band encoding utilizes some coding parameters from the low-band encoding algorithm;
In the high-band encoder, the encoding parameters are taken from the low-band encoder or generated locally based on the characteristics of the low-band and high-band signals;
The locally generated encoding parameters are tuned based on the low-band (core) encoder performance and low-band signal characteristics.

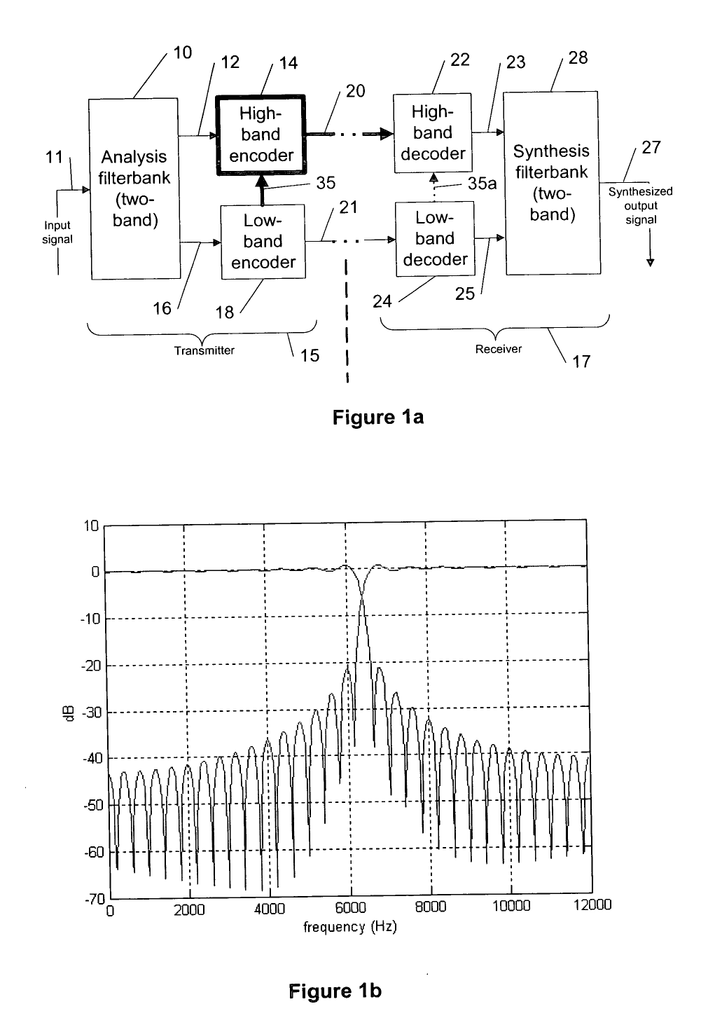

FIG. 1 a shows an example among many others of a general block diagram demonstrating a band-split encoding/decoding concept for adjusting the bandwidth extension algorithm using the high-band encoded signal adaptation with two band filterbanks and separate encoders and decoders for each audio band, according to the present invention.

The input signal 11 is first processed through a two-band analysis filterbank 10 in which the audio band is split into a high-band signal 12 and a low-band signal 16 which are then critically down-sampled by said filterbank 10. The high-band signal 12 and the low-band signal 16 are then encoded by a high-band encoder 14 and a low-band encoder 18, respectively. The key innovation described by the present invention is that the high-band encoder 14 adjusts one or more of the enhancing perception parameters of the high-band encoded signal 20 (thus adjusting the bandwidth extension algorithm) based on the characteristics of the input signal 11 which is communicated to the high-band encoder 14 by the low-band encoder 18 using an indication signal 35 as described below in detail. The multiplexed bit stream is transmitted through a communication channel to the receiver in which the high-band encoded signal 20 and a low-band encoded signal 21 are decoded by a high-band decoder 22 (optionally using a further indication signal 35a, identical to the signal 35, as explained below) and a low-band decoder 24, generating a high-band decoded signal 23 and a low-band decoded signal 25, respectively. The decoded signal is up-sampled to the original sampling frequency after which a synthesis filterbank 28 combines the signal thus generating a synthesized output signal 27. As shown in FIG. 1a, the high-band and low-band encoders 14, 18 along with the analysis filterbank 10 form a transmitter 15 of the input signal 11 and the high-band and low-band decoders 22, 24 with the synthesis filterbank 28 form a receiver 17 of said re-transmitted input signal 11 after the signal 11 is spectrally encoded in said M bands with said adjustment applied to the high-band encoded signal 20. The principle of the band-split encoding/decoding concept for adjusting the bandwidth extension algorithm shown in FIG. 1a can be applied to a variety electronic devices and network elements. For example, the transmitter 15 or the receiver 17 can be a part of a portable electronic device, an electronic communication device, a mobile electronic device, a mobile phone or a communication network element.

The low-band encoder 18 and decoder 24 can be implemented, for example, as AMR-WB standard encoder and decoder, respectively, whereas the high band encoder 14 and decoder 22 can use either an independent coding algorithm, a bandwidth extension algorithm or their combination thereof.

FIG. 1b shows an example among many others of a frequency response of a two-band analysis filterbank 10 for a 12 kHz audio band, which can be used in the block diagram of FIG. 1a, according to the present invention. In the case of using the AMR-WB+ algorithm, the 12 kHz audio band is divided into 0-6.4 and 6.4-12 kHz bands. The output signals of the filterbank 10 are critically down-sampled. That is, the low band is down-sampled to 12.8 kHz and the high band is re-sampled to 11.2 kHz by said filterbank 10.

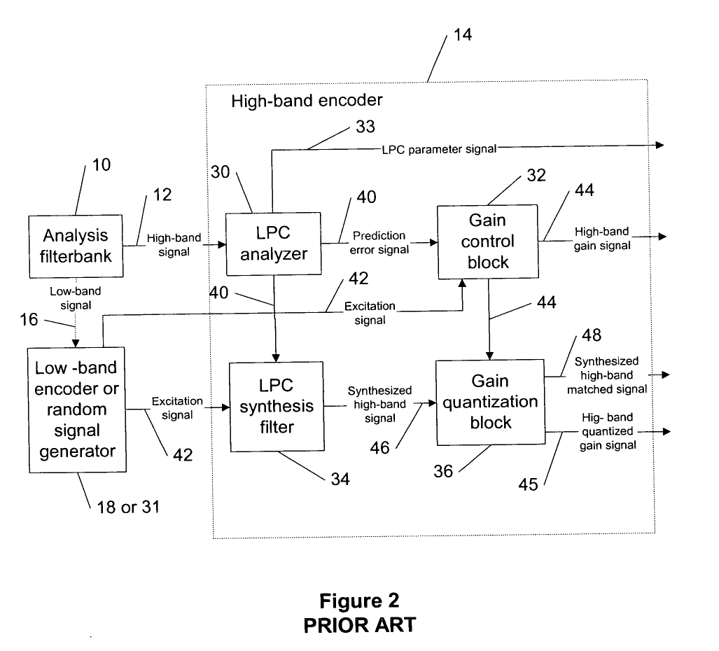

FIG. 2 shows an example among others demonstrating a functionality of a high-band encoder 14, according to the prior art. FIG. 2 presents the conventional (per the prior art) bandwidth extension algorithm. The high-band signal 12 is processed by an LPC analyzer 30 to model the spectral envelope of the high-band signal 12 and generate a prediction error signal (or a residual signal) e(n) 40 , wherein n is a frame number, and providing the signal 40 to a gain control block 32 and to a high-band LPC synthesis filter 34. The LPC parameters which are used for minimization of the prediction error signal 40 are quantized and transmitted (an LPC parameter signal 33) to the bandwidth extension (high-band) decoder 22 (shown in FIG. 1a) in the receiving end.

The bandwidth extension algorithm can calculate and quantize the excitation signal. In order to utilize the correlation between LPC residuals of the low and high bands, the low-band encoder excitation signal (which is quantized) can be copied to the high band as an excitation signal exc(n) 42. Hence, a synthesized high-band encoded signal 46 is generated by filtering the re-sampled low-band excitation signal 42 through the high-band LPC synthesis filter 34 (said re-sampling can be performed by a block not shown in FIG. 2). Another approach can be generating a random excitation signal 42 by a random signal generator 31. Based on the low-band and high-band encoded signal characteristics either the re-sampled low-band excitation or the random excitation signal 42 is selected for the high band. To align a synthesized signal energy of the synthesized high-band encoded signal 46 with the energy of the original high-band signal 12, the high band signal gain needs to be calculated and transmitted to the receiving end.

A gain control block 32 matches the energies of the LPC prediction error signal e(n) 40 and the excitation signal exc(n) 42. The function of the block 32 is to find a gain g, a high-band gain signal 44, that matches the energies such that
e(n)^{T}e(n)=g×exc(n)^{T}exc(n) (1).

An LPC synthesis filter 34 performs an inverse process to the one performed by the LPC analyzer 30. When the block 30 does the analysis of the signal and removes the short-term correlation, the block 34 reconstructs the redundancy (dynamics) thus generating a syntherzized high-band encoded signal 46.

A gain quantization block 36 performs the quantization of the gain g (the high-band gain signal 44) generating a high-band quantized gain index signal 45. Basically, the gain value is mapped into a table and the output is the index to that table entry. In the de-quantization phase in the decoder 22 the gain value is reconstructed by retrieving the value from the table with the index entry. Block 36 also generates a matched synthesized high-band encoded signal 48, i.e., the energy of the synthesized signal is set to the same level to that of the input (original) signal 11. Thus the high-band encoded signal 20 (shown in FIG. 1a) can include the signals 33, 44, 45 and 48.

Adjusting the synthesized high-band signal energy 46 to that of the original high-band signal 12 can cause problems when the signals do not match well enough. Especially if a speech signal containing clearly audible components in the high-band signal 12 that the simple excitation signal 42 cannot reconstruct and the coding artifacts can become unnecessary loud. Therefore, it is desirable to adapt the high-band signal 12 in case of a speech signal. This problem is solved using the present invention.

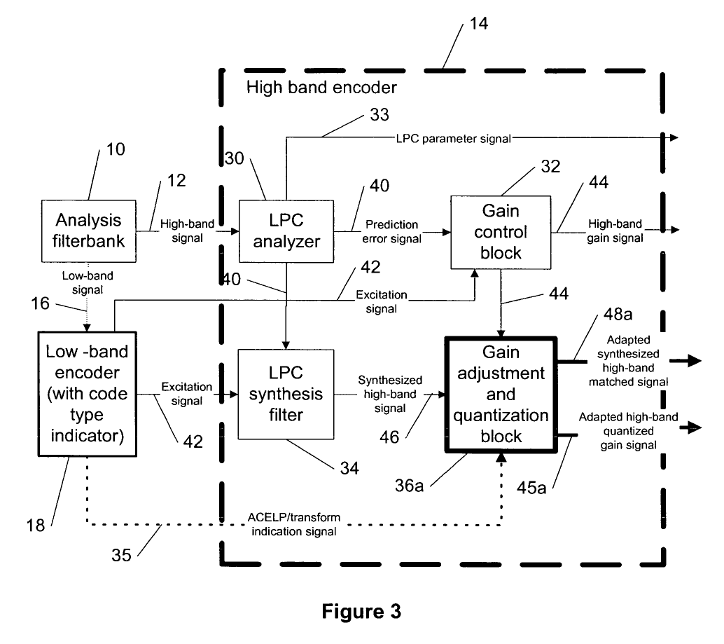

FIG. 3 shows an example among others demonstrating a functionality of a high-band encoder 14 with a high-band encoded signal adaptation, according to the present invention. After the high-band gain signal 44 is adjusted according to the original high-band signal 12 (see Equation 1), the gain is further tuned down based on the signal characteristics.

According to the present invention, the new method adaptively controls one or more of the enhancing perception parameters (e.g., a signal level, a signal energy and/or a gain) of a high-band encoded signal 20 depending on the low-band coding algorithm. At least two types of said algorithm can be used: e.g., the ACELP pulse-like algorithm and the transform coded TCX algorithm. For the ACELP coding algorithm, according to the present invention, the method suppresses a high-band energy in order to avoid audible high frequency noise components in a speech signal. More specifically, in order not to cause audible transients in the signal and not to suppress individual frames containing transients, the high-band encoded signal is adaptively tuned based on the signal mode. The appropriate coding is selected by the indication signal 35 provided to the gain adjustment and quantization block 36a by the low-band encoder 18. This indication signal 35 can be just a flag indicating either the ACELP or the transform mode. When the ACELP coding is selected, the corresponding enhancing perception parameter of the high-band encoded signal 20 is adapted downwards (gradually) on a frame-by-frame basis until it reaches a predetermined minimum threshold value. On the other hand, when the encoding algorithm is changed to the transform coding, the corresponding enhancing perception parameter of the high-band encoded signal 20 is gradually tuned back up to a normal level (a predetermined maximum threshold value) optimal for non-speech signals like music. Said predetermined threshold value (minimum or maximum) can be determined based on the input signal 11, or can be optionally provided by a sender of the input signal 11. Thus the output signals of the gain adjustment and quantization block 36a are an adapted high-band quantized gain signal 45a and an adapted matched synthesized high-band encoded signal 48a.

The enhancing perception parameter can be adapted both before and after the quantization of the parameter values. In case the parameter is adapted before it is quantized, there is no need to perform the corresponding adaptation in the high-band decoder 22 of the receiver 17. The parameter is transmitted to the receiver 17 as such and the decoder 22 does not need to have any information about the adaptation. However, the adaptation can be done after the quantization. In this case, the decoder 22 needs to perform the identical adaptation to keep synchronization with the adaptation performed by the high-band encoder 14. The encoding and decoding mode involving adjustment (adaptation) of the enhancing perception parameter then, according to the present invention, is known to both the encoder 14 and the decoder 22 (e.g., based on the identical information contained in the indication signal 35 and a further indication signal 35a as shown in FIG. 1). Hence, the adaptation can be triggered in the high-band decoder 22 without any additional information from the transmitter 15.

An example of the algorithm used for implementing the high-band encoded signal adaptation according to the present invention is given below.

A gain control block 32 matches the energies (in one possible scenario) of the LPC prediction error signal e(n) 40 and the excitation signal exc(n) 42. The function of the block 32 is to find a gain g (the high-band gain signal 44) that matches the energies of signals 40 and 42 as described by Equation 1.

The energy of the high-band LPC prediction error signal e(n) 40 is given by
E(n)=e(n)^{T}e(n).

The energy of the high-band excitation signal exc(n) 42 is given by
Eₑₓ(n)=exc(n)^{T}exc(n).

A scaling factor S is given by

$$S = \sqrt{\frac{E ( n )}{{E}_{ex} ( n )}} ,$$

which can written in dB domain as
S(dB)=20*log₁₀ S.

The one or more of the enhancing perception parameters of the high-band encoded signal 20 can be adapted by adjusting the scaling factor in dB domain by a tuning factor TF as
S_{adopted}(dB)=S(dB)−TF(dB).

The tuning factor is varied according to the signal characteristics. The tuning factor TF is first set to a certain constant after which its value is adapted in each analysis frame according to the following algorithm:
IF (mode=ACELP)
TF=0.95*TF;
ELSE
TF=1.05*TF.

Naturally, certain upper and lower limits need to be defined for the tuning factor. Since the tuning is done before the quantization, there is no need to send any adaptation information to the decoder 22. After tuning, the scale factor is further quantized in dB domain similar to the prior-art situation.

FIGS. 1a, 1b and 3 demonstrate only few possible scenarios for the implementation of the present invention. There are many variations. For example, it can be more than two audio bands generated by the filterbank 10 with the corresponding number of encoders and decoders. Thus the present invention can be generally applied to a multi-band system with M audio-band signals generated by the analysis filterbank 10 by splitting the input signal into M frequency bands (M is an integer of at least a value of two) and a band frequency range of the high-band encoded signal (chosen from said M bands) is higher than the band frequency range of the low-band signal (chosen from said M bands as well), when the adaptation method described by the present invention is applied. Also different coding methods can be used by the low-band encoder besides the ACELP or transform algorithms.

1. A method of adjusting a bandwidth extension algorithm for band-split encoding and decoding using analysis and synthesis filterbanks and separate encoders and decoders for each band, comprising the steps of:
receiving by a high-band encoder an indication signal generated by a low-band encoder in response to a low-band signal from said analysis filterbank; and
adjusting by the high-band encoder an enhancing perception parameter of a high-band encoded signal generated by the high-band encoder in response to a high-band signal from said analysis filterbank and based on said indication signal thus adjusting said bandwidth extension algorithm,
wherein the high-band signal and the low-band signal represent two signals out of M frequency-band signals generated by the analysis filterbank by splitting an input signal into M frequency bands, M is an integer of at least a value of two and a band frequency range of said high-band signal is higher than the band frequency range of said low-band signal, and wherein the high-band and low-band encoders with the analysis filterbank form a transmitter of the input signal and the high-band and low-band decoders with the synthesis filterbank form a receiver of a re-transmitted input signal which is spectrally encoded in said M bands with said adjustment applied to the high-band encoded signal.

2. The method of claim 1, wherein prior to said adjustment said enhancing perception parameter is generated in response to an excitation signal from the low-band encoder or from a random signal generator.

3. The method of claim 1, wherein said enhancing perception parameter is a signal level, a gain, or a signal energy, or their combination thereof.

4. The method of claim 1, wherein M=2.

5. The method of claim 1, wherein said indication signal is an indicator of an algebraic code excitation linear prediction (ACELP) type of coding used by the low-band encoder for generating the low-band signal for the input signal which is speech-like.

6. The method of claim 5, wherein, based on said indication signal, said enhancing perception parameter is gradually adjusted downwards towards a minimum threshold value until said threshold value is reached.

7. The method of claim 1, wherein said indication signal is an indicator of a transform type of coding used by the low-band encoder for generating the low-band signal for the input signal which is non-speech-like.

8. The method of claim 7, wherein, based on said indication signal, said enhancing perception parameter is gradually adjusted upwards towards a maximum threshold value until said threshold value is reached.

9. The method of claim 1, wherein, based on said indication signal, said enhancing perception parameter is gradually adjusted towards a threshold value until said threshold value is reached.

10. The method of claim 9, wherein said threshold value is a predetermined value, determined based on the input signal or provided by a sender of the input signal.

11. The method of claim 9, wherein, said threshold value is a minimum threshold value and said enhancing perception parameter is gradually adjusted downwards towards said minimum threshold value until said minimum threshold value is reached or wherein said threshold value is a maximum threshold value and said enhancing perception parameter is gradually adjusted upwards towards a maximum threshold value until said maximum threshold value is reached.

12. The method of claim 11, wherein the maximum threshold or the minimum threshold is a predetermined value.

13. The method of claim 1, wherein said enhancing perception parameter of the high-band encoded signal is quantized before said adjusting and, in response to the high-band encoded signal received by a high-band decoder, said enhancing perception parameter of a high-band decoded signal generated by said high-band decoder is adjusted by said high-band decoder based on a further indication signal containing identical information as said indication signal and generated by a low-band decoder in response to a low-band encoded signal from the low band encoder, thus further adjusting said bandwidth extension algorithm to keep synchronization with said adjustment performed by the high-band encoder.

14. A computer program product comprising: a computer readable storage structure embodying computer program code thereon for execution by a computer processor with said computer program code characterized in that it includes instructions for performing the steps of the method of claim 1 indicated as being performed by any component of the transmitter or of the receiver.

15. A system for adjusting a bandwidth extension algorithm for band-split encoding and decoding, comprising:
an analysis filterbank, responsive to an input signal, for providing M frequency-band signals generated by splitting the input signal into M frequency bands, wherein M is an integer of at least a value of two;
a high-band encoder, responsive to a high-band signal and to an indication signal, for providing a high-band encoded signal and for adjusting an enhancing perception parameter of the high-band encoded signal thus adjusting said bandwidth extension algorithm; and
a low-band encoder, responsive to a low-band signal, for providing said indication signal,
wherein the high-band signal and the low-band signal represent two signals out of said M frequency-band signals generated by the analysis filterbank and a band frequency range of said high-band signal is higher than the band frequency range of said low-band signal.

16. The system of claim 15, wherein prior to said adjustment said enhancing perception parameter is generated in response to an excitation signal from the low-band encoder or from a random signal generator.

17. The system of claim 15, wherein said enhancing perception parameter is a signal level, a gain, or a signal energy, or their combination thereof

18. The system of claim 15, wherein M=2.

19. The system of claim 15, wherein said indication signal is an indicator of an algebraic code excitation linear prediction (ACELP) type of coding used by the low-band encoder for generating the low-band signal for the input signal which is speech-like.

20. The system of claim 19, wherein, based on said indication signal, said enhancing perception parameter is gradually adjusted downwards towards a minimum threshold value until said threshold value is reached.

21. The system of claim 15, wherein said indication signal is an indicator of a transform type of coding used by the low-band encoder for generating the low-band signal for the input signal which is non-speech-like.

22. The system of claim 21, wherein, based on said indication signal, said enhancing perception parameter is gradually adjusted upwards towards a maximum threshold value until said threshold value is reached.

23. The system of claim 15, wherein, based on said indication signal, said enhancing perception parameter is gradually adjusted towards a threshold value until said threshold value is reached.

24. The system of claim 23, wherein said threshold value is a predetermined value, determined based on the input signal or provided by a sender of the input signal.

25. The system of claim 23, wherein said threshold value is a minimum threshold value and said enhancing perception parameter is gradually adjusted downwards towards said minimum threshold value until said minimum threshold value is reached or wherein said threshold value is a maximum threshold value and said enhancing perception parameter is gradually adjusted upwards towards a maximum threshold value until said maximum threshold value is reached.

26. The system of claim 25, wherein the maximum threshold or the minimum threshold is a predetermined value.

27. The system of claim 15, wherein said system is contained in a portable electronic device, an electronic communication device, a mobile electronic device, a mobile phone or a communication network element.

28. The system of claim 15, further comprising
a high-band decoder, responsive to the high-band encoded signal for providing a high-band decoded signal;
a low-band decoder, responsive to a low-band encoded signal generated by the low-band encoder, for providing a low-band decoded signal; and
a synthesis filterbank, responsive to the high-band decoded signal and to the low-band decoded signal, for providing a synthesized output signal,
wherein the high-band and low-band encoders with the analysis filterbank form a transmitter of the input signal and the high-band and low-band decoders with the synthesis filterbank form a receiver of a re-transmitted input signal which is spectrally encoded in said M bands with said adjustment applied to the high-band encoded signal.

29. An electronic device, capable of adjusting a bandwidth extension algorithm for band-split encoding, comprising:
an analysis filterbank, responsive to an input signal, for providing M frequency-band signals generated by splitting the input signal into M frequency bands, wherein M is an integer of at least a value of two;
a high-band encoder, responsive to a high-band signal and to an indication signal, for providing a high-band encoded signal and for adjusting an enhancing perception parameter of the high-band encoded signal thus adjusting said bandwidth extension algorithm; and
a low-band encoder, responsive to a low-band signal, for providing said indication signal and for providing a low-band encoded signal,
wherein the high-band signal and the low-band signal represent two signals out of said M frequency-band signals generated by the analysis filterbank and a band frequency range of said high-band signal is higher than the band frequency range of said low-band signal.

30. The electronic device of claim 29, wherein said electronic device is a portable electronic device, an electronic communication device, a mobile electronic device, a mobile phone or a communication network element.

31. The electronic device of claim 29, wherein prior to said adjustment said enhancing perception parameter is generated in response to an excitation signal from the low-band encoder or from a random signal generator.

32. The electronic device of claim 29, wherein said enhancing perception parameter is a signal level, a gain, or a signal energy, or their combination thereof.

33. The electronic device of claim 29, wherein M=2.

34. The electronic device of claim 29, wherein said indication signal is an indicator of an algebraic code excitation linear prediction (ACELP) type of coding used by the low-band encoder for generating the low-band signal for the input signal which is speech-like.

35. The electronic device of claim 34, wherein, based on said indication signal, said enhancing perception parameter is gradually adjusted downwards towards a minimum threshold value until said threshold value is reached.

36. The electronic device of claim 29, wherein said indication signal is an indicator of a transform type of coding used by the low-band encoder for generating the low-band signal for the input signal which is non-speech-like.

37. The electronic device of claim 36, wherein, based on said indication signal, said enhancing perception parameter is gradually adjusted upwards towards a maximum threshold value until said threshold value is reached.

38. The electronic device of claim 29, wherein, based on said indication signal, said enhancing perception parameter is gradually adjusted towards a threshold value until said threshold value is reached.

39. The electronic device of claim 38, wherein said threshold value is a predetermined value, determined based on the input signal or provided by a sender of the input signal.

40. The electronic device of claim 38, wherein said threshold value is a minimum threshold value and said enhancing perception parameter is gradually adjusted downwards towards said minimum threshold value until said minimum threshold value is reached or wherein said threshold value is a maximum threshold value and said enhancing perception parameter is gradually adjusted upwards towards a maximum threshold value until said maximum threshold value is reached.

41. The electronic device of claim 40, wherein the maximum threshold or the minimum threshold is a predetermined value.
